(19) United States
(12) Patent Application Publication
(10) Pub. No.: US 2002/0046145 A1
(43) Pub. Date: Apr. 18, 2002

(54) Method and system for analyzing performance of an investment portfolio together with associated risk

(76) Inventor: Korin Ittai, New York, NY (US)

Correspondence Address: Paul D. Greeley, Esq., Ohlandt, Greeley, Ruggiero & Perle, L.L.P., One Landmark Square, 10th Floor, Stamford, CT, 06901-2682, US

(21) Appl. No.: 09/866,965

(22) Filed: May 29, 2001

Related U.S. Application Data
(60) Provisional application No. 60/207,795, filed on May 30, 2000.
(60) Provisional application No. 60/240,994, filed on Oct. 17, 2000.

(51) Int. Cl. G06F 17/60

(52) U.S. Cl. 705/36; 705/38

(57) ABSTRACT

A method for analyzing an investment portfolio, comprises the steps of (a) receiving a communication from a user terminal, via a computer network to initiate a session for analyzing an investment portfolio for a user, (b) receiving a description of a financial instrument in the portfolio, and (c) calculating a risk for the financial instrument. Thereafter, the calculated risk is transmitted to the user terminal. A system for analyzing an investment portfolio is also provided.

### CROSS-REFERENCE TO RELATED APPLICATIONS

The present application is claiming priority of U.S. Provisional Patent Applications No. 60/207,795, which was filed on May 30, 2000, and No. 60/240,994, which was filed on Oct. 17, 2000.

### BACKGROUND OF THE INVENTION

1. Field of the Invention

The present invention is related generally to portfolio analysis and related risk assessment useful in the financial field. More particularly, the present invention provides a unique capability that enables investors to evaluate an existing or theoretical financial portfolio utilizing analytical tools and relevant historical market data via a network.

2. Description of the Prior Art

In the past, powerful tools used to optimize, simulate and evaluate the performance of a given investment portfolio have only been available to financial consultants and large institutional investors. These investors typically seek to maximize the expected or average return on an overall investment of funds for a given level of risk as defined in terms of variance of return, either historically or as adjusted using techniques known to persons skilled in portfolio management.

However, as an increasing number of less sophisticated investors attempt to manage their own portfolios via the management of their retirement savings or via electronic trading without the benefit of a financial analyst, there is an ever increasing demand for financial products that are capable of providing these investors with the same portfolio analysis tools available to professionals.

A number of computer financial analysis systems have been developed in recent years to help individuals select the best financial products to meet their needs. These systems typically perform analysis based upon mathematical models regarding mortgage refinancing and/or retirement planning and investment alternatives. However, these systems are very basic and do not provide the individual investor with the same level of sophistication as the analytical tools available to professional financial analysts.

Moreover, many of these financial analysis systems do not provide realistic estimates of the retirement horizon risk-return tradeoff given a user's specific investments and financial circumstances. This makes informed judgments about the appropriate level of investment risk very difficult. The notion of a risk-return trade off is fundamental to modern portfolio theory, and any system that fails to convey long-term risk and return fails to provide information essential to making informed investment decisions.

Many individual investors also lack a basic knowledge of portfolio theory. They have a general idea of what they have at risk and how, but lack the ability to quantify their risk in actual dollar terms and perform exacting, real and useful analysis on their current set of investments. What is needed is a powerful, yet accessible set of tools that will allow the investor to analyze the performance of his or her existing portfolio, determine how their investment decisions have affected their portfolio in the past, and better understand the behavior of their portfolio in the future in order to make better investment decisions going forward.

Conventional financial analytical tools allow only the price tracking of each instrument in a portfolio or simulation and back testing capabilities in order to test out mathematical trading systems. None have allowed the investor to quickly understand crucial characteristics of their investments and how to correctly use and interpret these characteristics. These systems have been limited in their sophistication, such as in number of instruments tracked and length of historical data, as well as in number of tools that can be applied to the data. Most importantly, these systems were not packaged as powerful, yet easily accessible and deliverable systems.

### SUMMARY OF THE INVENTION

The present invention overcomes the aforementioned problems associated with conventional financial analysis systems by providing a method for analyzing an investment portfolio, comprising the steps of (a) receiving a communication from a user terminal, via a computer network, to initiate a session for analyzing an investment portfolio for a user, (b) receiving a description of a financial instrument in the portfolio, and (c) calculating a risk for the financial instrument. Thereafter, the calculated risk result is transmitted to the user terminal. A system for analyzing an investment portfolio is also provided.

The present invention provides a unique method for instantly accessing or composing the make-up of an individual's portfolio via a network (e.g., the Internet), obtaining risk and performance measurements, determining how the performance relates to that of any or several markets, both currently and over the course of a historical data set. The present invention determines individual instrument performance, as well as portfolio-wide performance characteristics, which heretofore have not been possible. The present invention also provides a method and system for simulating a theoretical portfolio and associated risk, and thereafter generating a trade list to implement the simulated results.

By breaking down barriers of availability to sophisticated portfolio analysis tools, both in terms of algorithms and computing power, the present invention revolutionizes the analytical and strategic ability of the individual investor. By making readily available a system to quickly build a complex portfolio, analyze its performance over time, and clearly determine its behaviors (i.e., individual instrument risk, daily volatility, sector risk, market correlation, returns analysis) the present invention empowers the individual investor in ways never before possible.

Moreover, the present invention eliminates the difficulty of information management. The complexities of maintaining a historical database, analysis results and performance measures, as well as current market condition variables, historical market variables, and personal performance characteristics are taken out of the hands of the user. This results in powerful analytical and decision making capabilities as well as ease of use.

The present invention provides for a novel approach that allows individual investors to easily apply powerful mathematical tools in order to examine the behavior of their portfolios, thereby providing them with a sophisticated method of portfolio analysis, and the ability to make better informed investment decisions. Utilizing the present invention, individual investors will be able to foster a better understanding of what he or she has at risk and why.

The present invention also provides many additional advantages, which shall become apparent as described below.

### BRIEF DESCRIPTION OF THE DRAWINGS

FIG. 1 is a flow chart of the portfolio analysis system according to the present invention.

FIG. 2 is a flow chart used to compile a portfolio for use in FIG. 1.

FIG. 3 is a flow chart depicting the various types of analysis that can be performed utilizing the system of the present invention.

FIG. 3a is a flow chart depicting an asset specific analysis according to the present invention.

FIG. 3b is a flow chart depicting a sector analysis according to the present invention.

FIG. 4 is a flow chart depicting the general processing steps taken during any analysis according to the system of the present invention.

FIG. 5 is a flow chart depicting the general processing steps utilized in calculating the returns of a specific instrument, asset, sector or entire portfolio.

FIG. 6 is a flow chart depicting the general processing steps utilized in calculating a dollar risk amount of a specific instrument, asset, sector or entire portfolio.

FIG. 7 is a schematic representation of a network that implements the portfolio analysis system according to the present invention.

FIG. 8 is a flow chart depicting the historical analysis system according to another embodiment of the present invention.

FIG. 9 is a flow chart depicting the general processing steps utilized in determining the analysis target of FIG. 8.

FIG. 10 is a flow chart depicting the general processing steps utilized in determining the time frame of FIG. 8.

FIG. 11 is a flow chart depicting the general processing steps utilized in generating the position signals of FIG. 8.

FIG. 12 is a flow chart depicting the general processing steps utilized in retrieving historical data of FIG. 8.

FIG. 13 is a flow chart depicting the general processing steps utilized in setting the analysis parameters of FIG. 8.

FIG. 14 is a flow chart depicting the general processing steps utilized in performing the analysis of FIG. 8.

FIG. 15 is a flowchart showing the steps for accessing the portfolio simulation tool in accordance with the present invention.

FIG. 16 is a flowchart showing the details of the simulation analysis in accordance with the present invention.

FIG. 17 is a flowchart showing the details of the Portfolio-Wide Risk Simulation in accordance with the present invention.

FIG. 18 is a flowchart showing the details of the Individual Position Risk Simulation in accordance with the present invention.

FIG. 19 is a flowchart showing the details of the Individual Position Quantity Simulation in accordance with the present invention.

FIG. 20 is a flowchart showing the details of the New Instrument Simulation in accordance with the present invention.

### DETAILED DESCRIPTION OF THE PREFERRED EMBODIMENT

Before proceeding with a description of the present invention, it is well to define certain terms as used herein.

Dollar Risk: A calculated dollar amount that can be gained or lost in a specific investment.

Return: An absolute or percentage amount gained or lost in an investment over a given time period.

Asset: A financial instrument that is the target of investment.

Asset Class: A logical grouping of assets into a category whose members share common traits. For example, all stock investments are grouped into an asset class know as Equities, since they all commonly represent equity positions in various companies. All currency positions in a portfolio are grouped into an asset class labeled foreign exchange.

Market Sector: A logical grouping of assets into companies that belong to the same class of business. For example, all stocks of technology related companies are labeled technology sector stocks.

Price Volatility: A mathematical representation of the size of the expected fluctuation in the price of an asset. More technically, it is the standard deviation, which is the average size of the square of the deviation of a price from its mean.

Historical Price Volatility: A measurement of price volatility taken over a set of prices occurring over a historical time period such as a week, a month, a year, or several years.

Value At Risk: A measurement used to estimate the potential loss or gain in a given investment or set of investments. Historical value at risk (VAR) uses historical price volatility and a statistical distribution to approximate the behavior of an asset's, or group of assets', future price behavior. The approximation is calculated within a given range of confidence. The result is an estimation of potential loss or gain with a 95% degree of confidence and a 5% degree of error.

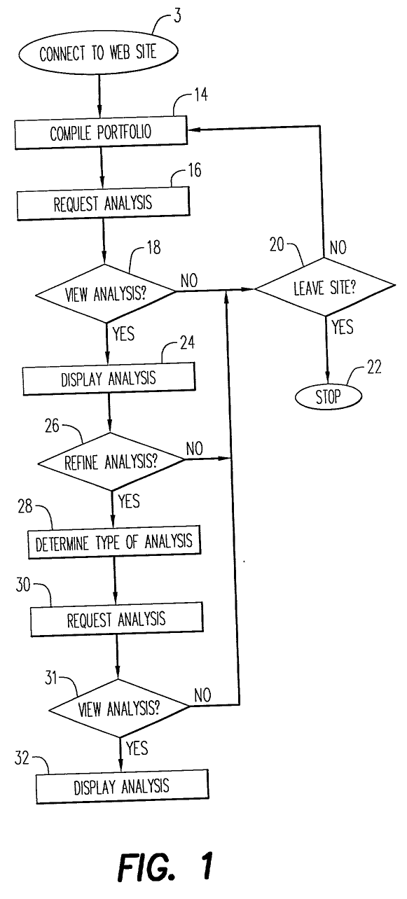

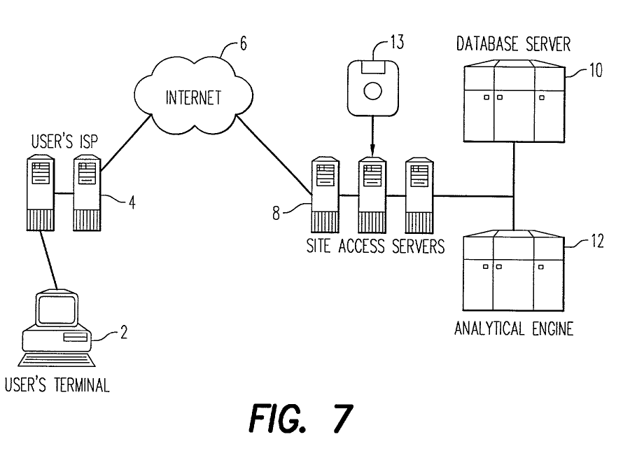

FIGS. 1 and 7 depict the portfolio analysis system according with the present invention, wherein user 2 connects to a web site 3 via an Internet service provider 4 and Internet 6 to the online application maintained on site access servers 8 and supported by database server 10 and analytical engine 12.

While the procedures required to execute the invention hereof are indicated as already loaded into servers 8, they may be configured on a storage media 13, for subsequent loading into servers 8. Storage media 13 may be any conventional data storage device such as, but not limited to, a magnetic disk, a magnetic tape, a read only memory, a random access memory, a hard disk or a floppy disk, or an optical storage media.

After connecting to web site 3, the portfolio is compiled 14 via online database server 10 or list of financial instruments. Conversely, the user may link to another Internet site where he or she is already maintaining a portfolio. If a user has already taken steps to maintain another online portfolio on a separate remote database or website, several different types of interface programs and schemes exist to automatically transfer the user's remote information and automatically load it in to the present web site. Some examples of this industry standard technology are XML and HTML parsing programs. These simply load the remote website pages and then sift through the displayed information seeking the desired data.

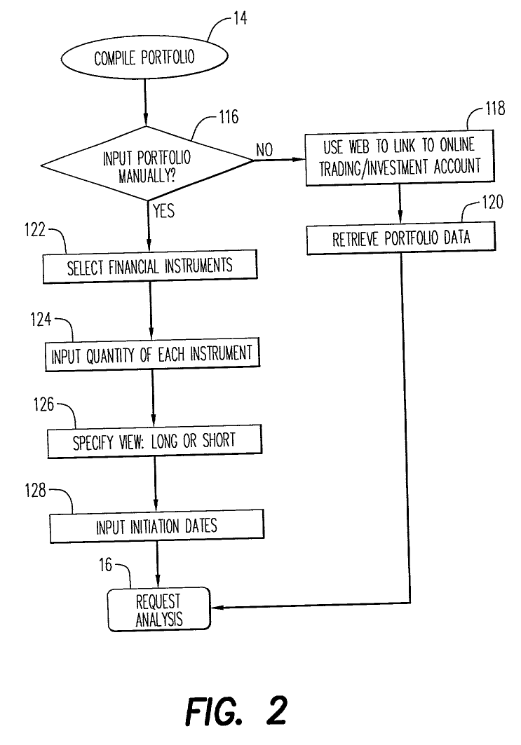

FIG. 2 depicts a compilation of a portfolio 14, wherein the user is requested whether he or she would like to input the portfolio manually 116. If not, the user is connected via the Internet to link to an online trading/investment account 118 where the portfolio data can be retrieved 120 and forwarded to request analysis step 16 of FIG. 1. At step 116, if user elects to manually input the portfolio, then the user must select the desired financial instruments 122, input quantity of each instrument 124, specify view (i.e., long or short) 126 and input initiation dates 128, and then proceed to request analysis 16.

Referring again to FIG. 1, after the portfolio is compiled in step 14, the system performs request analysis in step 16, which includes the performing of returns, risk, and comparison study in order to understand the risk of the portfolio. Thereafter, the user selects whether to view the analysis results in step 18. If no, then in step 20, the user is asked whether he or she would like to leave the web site. If the user wants to leave the web site, then the analysis is terminated in step 22. If user does not want to leave the web site, then the user is returned to portfolio compilation step 14. In step 18, if user elects to view the analysis, then the results are displayed in step 24 on a cathode ray tube (CRT) or other machine viewable device.

After reviewing the display of the analysis in step 24, in step 26 the user is asked whether to refine the analysis. If the user elects not to refine the analysis, then the process branches to step 20 where the user is prompted to leave the site, as described earlier. If in step 26 the user elects to refine the analysis, then in step 28 he or she is prompted to determine what type of analysis is required. The process then advances to step 30 where the analysis is performed. The process then advances to step 31.

In step 31 the user indicates whether he or she desires to view the analysis. If the user does not indicate a desire to view the analysis, then the process branches back to step 20. If the user indicates a desire to view the analysis, the process advances to step 32 where the analysis is displayed.

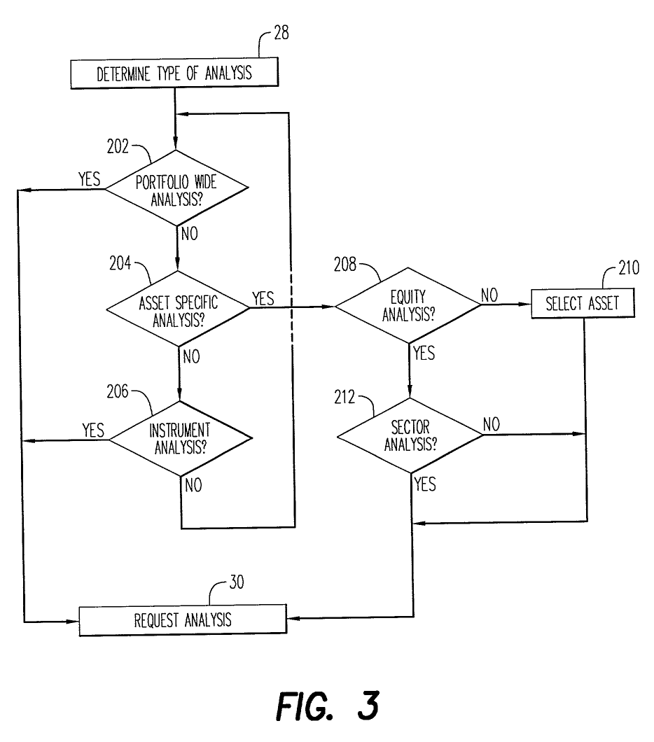

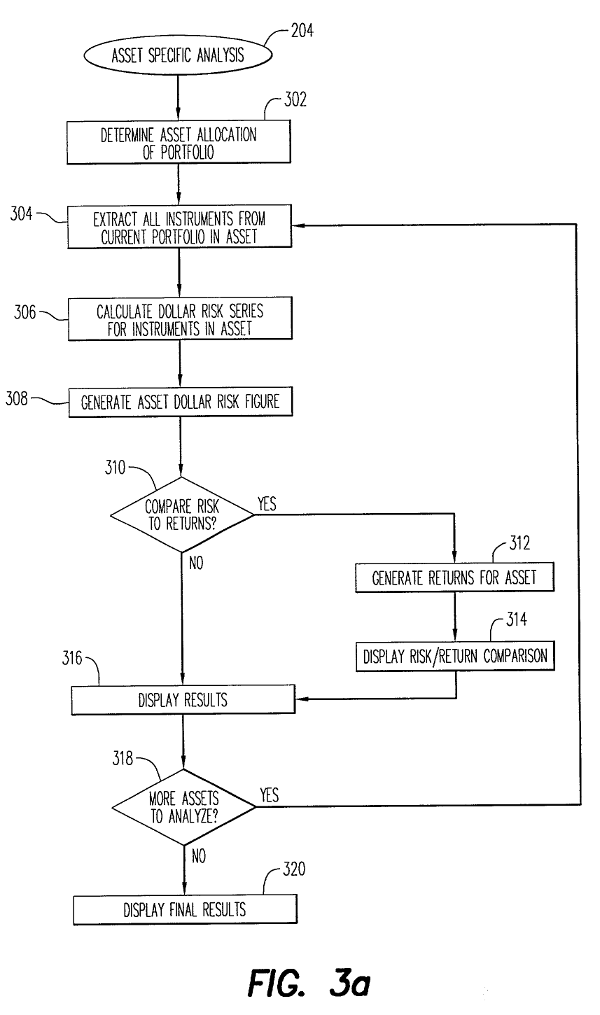

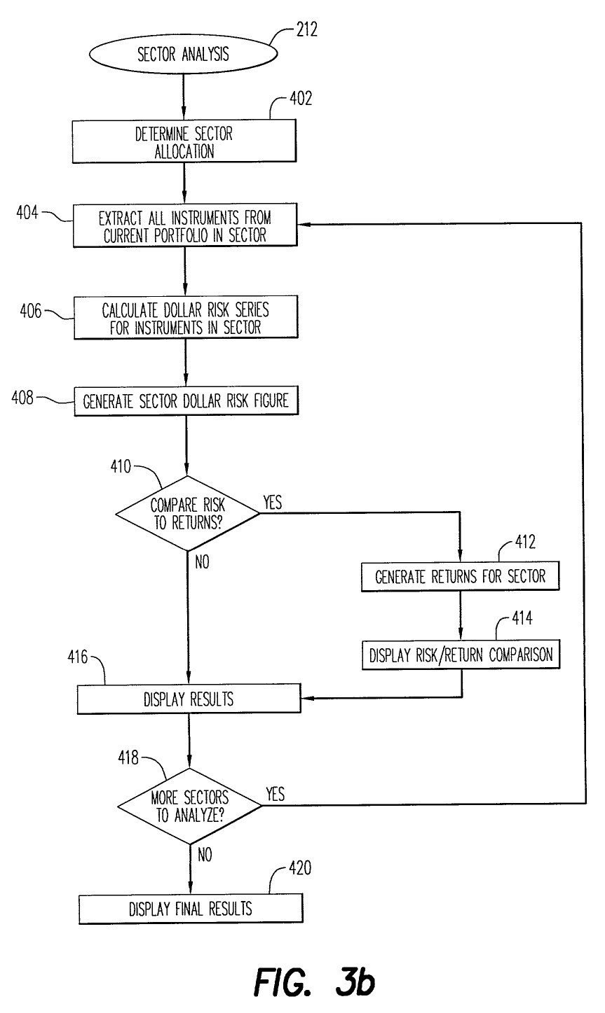

FIG. 3 outlines the types of analysis that the system of the present invention provides. User may select from a portfolio-wide analysis 202, an asset specific analysis 204 or an instrument analysis 206. When the portfolio-wide analysis 202 or instrument analysis 206 is selected the system then requests that such analysis is run 30. If asset specific analysis 204 is selected, then the user is prompted to select an equity analysis 208 to determine if the assets to be analyzed are stocks. If the assets are not stocks, then the user is prompted to select a specific asset 210 before requesting analysis 30. If the assets are stocks, then the user may select to analyze the stocks by sector 212. If the user decides not to seek a sector analysis, then his equity analysis request is complied with.

FIG. 3a is a subsystem that runs the asset specific analysis 204 of FIG. 3, wherein the user is allowed to isolate a specific asset to be analyzed. Given a portfolio of stocks, commodities, currencies and bonds, a user may want to study the risk and returns of his or her stock risk only, and then see how the results relate to the portfolio as a whole. This subsystem determines the asset allocation of the portfolio to be analyzed 302. Determining the asset allocation 302 involves the determination of the portfolio asset allocation. In this way, the system can separate the portfolio components into logical asset groups, e.g., stocks, bonds, commodities, currencies. The system then extracts all of the instruments from the current portfolio of assets 304 (i.e., extracts, from the portfolio, all instruments that fall within the specific asset group to be analyzed), calculates the dollar risk figure for the instruments 306 and generates the aggregate asset dollar risk FIG. 308.

Thereafter, the user is asked to compare 310 the dollar risk figure generated in 308 to the returns of the asset. If the user requests that the system compare risks to returns 310, then the system generates a return for the asset 312 and also displays the results of the risk/return comparison 314. If the user did not wish to make the comparison in step 310, then the results of each of steps 302, 304, 306 and 308 are outputted for display 316.

Thereafter, the system checks to determined whether the user requires that additional assets be analyzed 318. If so, the system returns to step 304 until there are no more logical asset groups to analyze. Once all of the asset groups have been analyzed a final display is presented 320.

The sector analysis process 212 depicted in FIG. 3b is substantially similar to the process outlined in FIG. 3a, above. The two processes differ only in that FIG. 3b is calculating the risk of logical market sector groups if the asset analyzed is stocks. This subsystem determines the asset allocation of the portfolio to be analyzed 402. Determining the sector allocation 402 involves the determination of the portfolio sector allocation. In this way, the system can separate the portfolio components into logical sector groups. The system then extracts all of the stocks from the current portfolio of the sector 404 (i.e., extracts, from the portfolio, all stocks that fall within the specific sector to be analyzed), calculates the dollar risk series for the stocks 406 and generates the sector dollar risk FIG. 408.

Thereafter, the user is asked to compare 410 the dollar risk figure generated in 408 to the returns of the sector. If the user requests that the system compare risks to returns 410, then the system generates a return for the sector 412 and also displays the results of the risk/return comparison 414. If the user did not wish to make the comparison in step 410, then the results of each of steps 402, 404, 406 and 408 are outputted for display 416.

Thereafter, in step 418, the system prompts the user to determine whether the user desires an analysis of an additional sector. If so, the system returns to step 404 until there are no more logical sectors to analyze. Once all of the sectors have been analyzed a final display is presented 420.

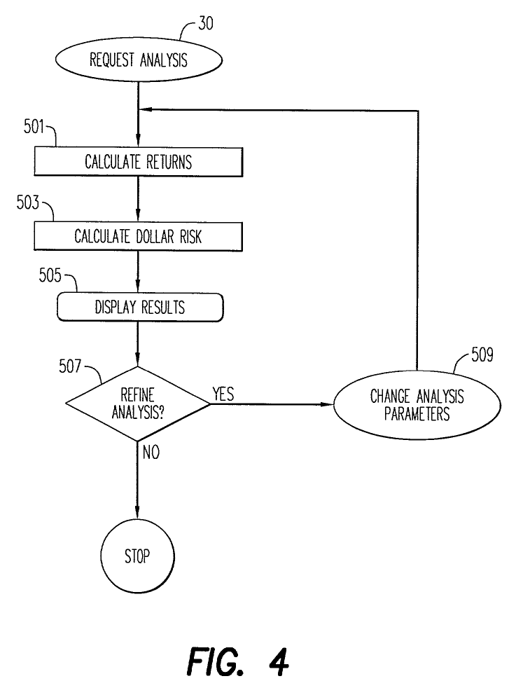

FIG. 4 describes the general steps taken by the system when an analysis is requested 30 from any level, instrument, asset, sector, or portfolio-wide. The steps are to calculate returns 501, calculate dollar risk 503, display results 505, and provide user option to refine analysis 507. If the user desired to refine the analysis, then the analysis parameters are changed 509 and the process returns to step 501. If not, the subroutine is terminated.

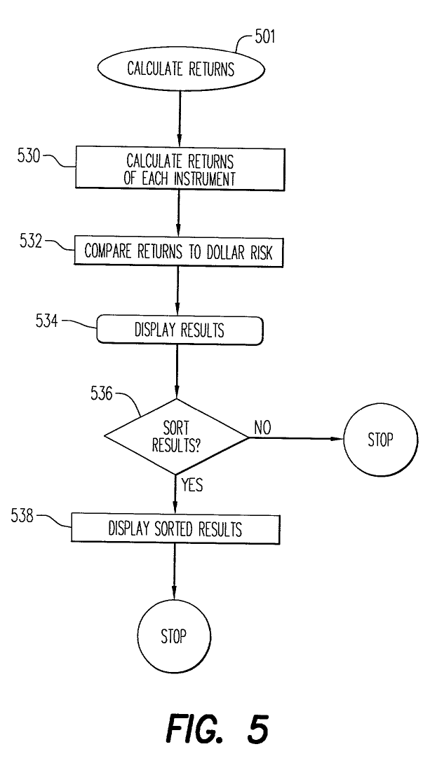

FIG. 5 describes the general steps taken by the system in order to calculate the returns 501 of an instrument, asset, sector or portfolio. Initially, the returns of each instrument are calculated 530, followed by a comparison of the returns to a previously generated dollar risk FIG. 532, and thereafter displaying the results 534. The user is thereafter prompted as to whether or not he or she wishes to sort the results 536. If the user chooses to sort results, then the sorted results are displayed 538. If the user opts not to sort the results, then the subroutine is terminated.

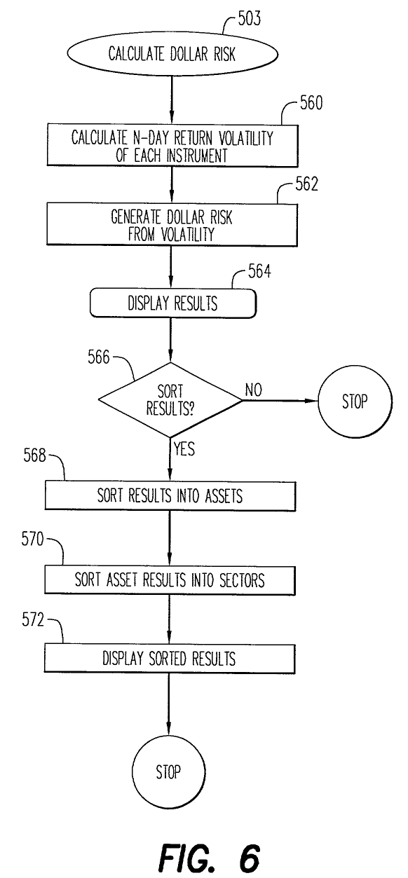

FIG. 6 describes the general steps taken by the system in order to calculate a dollar risk FIG. 503 for an instrument, asset, sector, or portfolio as a whole. Return volatility is the volatility of a returns time series. For the given logical group, the N-day return volatility is generated 560, where N is the historical window used to create the result. The dollar risk FIG. 562 is calculated by applying a statistically significant multiplier to the previously calculated volatility.

The dollar risk calculation consists of three parts: Returns calculation, Returns Volatility Calculation, and Dollar Risk Calculation.

Returns Calculation

Given a time series of historical price data for a specific financial instrument (or a plurality of financial instruments) in a financial portfolio, a time series consisting of the returns is generated. The returns of the data series is defined as a series whose points are the value of the difference between each successive historical data point in the input data series.

For a given data series, X, the resulting return series, R is calculated by:

Rᵢ=Xᵢ−X₍ᵢ₋₁₎,

where i goes from 2 to Length of X.

Thus, the resulting time series, R is one point shorter than X.

For example,

X={1,2,3,5,8}

R={1,1,2,3}

The periodicity of the calculation is defined by the periodicity of the inputted price series, X. If the period of X is daily, the resulting returns array, R, will have a daily periodicity as well. Conversely, if the period of X is monthly, then the periodicity of R will also be monthly.

Returns Volatility Calculation

For a given a time series of returns data, R, a volatility measurement is calculated. The volatility is calculated by taking the standard deviation of the returns time series.

$$\sqrt{\frac{n \sum {R}_{i}^{2} - {( \sum {R}_{i} )}^{2}}{n ( n - 1 )}}$$

where i goes from 1 to n and n Length of R.

Thus, the result is a volatility calculation for the return series R.

The range of the variable, i, is dependent upon the historical range of the calculation. Limiting i to the last n points in the series, controls the historical sample set of the calculation. For example, a 30 day volatility calculation measurement would involve i ranging from (Length of R)−30 to Length of R. Thus, the sample set for the calculation would therefore be the last 30 days of the series and would yield a 30 day volatility measurement.

Dollar Risk Calculation

Now that a volatility figure has been calculated for a given returns time series, R, one can arrive at a dollar risk figure:

Dollar Risk=Volatility*Scaling Factor,

where the Scaling Factor, S,=A fractional area under a statistical distribution curve. Dollar Risk is also known as the Value at Risk (VAR).

In a specific embodiment of the invention, the sampled statistical distribution curve can be a Normal distribution curve. A Normal distribution is a continuous, bell-shaped, and symmetric distribution. It can be fully described by two parameters, mean and standard deviation. The Normal distribution is symmetric about its mean and can take on values from negative infinity to positive infinity. Using a Normal distribution to scale the volatility measurement assumes that the returns of the given financial instrument (or plurality of instruments) are normally distributed. Using a Normal distribution curve also assumes that the returns of the instrument (or plurality of instruments) are dependent upon applicable risk factors, such as, the price of a stock, or an exchange rate.

There are other distributions that can be used in order to generate scaling factors. These are appropriate under different assumptions of returns dependencies. Returns that are non-linear, or that depend upon non-linear risk factors cannot be modeled accurately using a normal distribution curve. For example, a portfolio consisting of options and mortgage backed securities that depend upon convexity and gamma risk, cannot be accurately modeled using a Normal distribution curve.

A Normal distribution is fully described with just two parameters: its mean μ, and standard deviation, σ. These provide all the information needed to determine any statistical measure of VAR related to the portfolio's profit/loss distribution. For example, if the VAR is defined as the maximum loss that can occur within a 95% confidence interval, the measure of VAR will be:

1.65σ−μ

where 1.65σ maps to 95% of the area under the Normal distribution curve, and where μ is the average one-period risk-free return plus a spread for any systematic risk the portfolio may be taking. In practice, where VAR is computed over short horizons, μ is small. Typically, it is set equal to zero. The VAR estimate then simplifies to:

1.65σ

Therefore, the VAR is then the standard deviation of the plurality of instruments multiplied by a scaling factor, in this case, 1.65 standard deviations.

After the dollar risk is generated the results are displayed 564 for review by the user. Again, the user is queried as to whether or not the results should be sorted 566. If the results are to be sorted, the subroutine will sort the results of the calculation into logical asset 568 or sector 570 groups (if not sorted already by previous steps in the system process), and thereafter display the sorted results 572. If the user opts not to sort the results, then the subroutine is terminated.

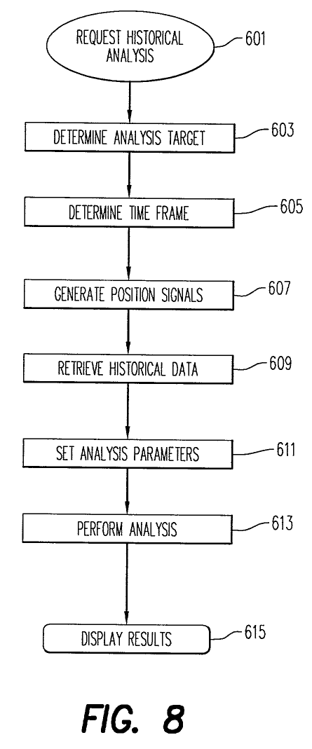

FIG. 8 describes the process through which a user can execute historical analysis of the online portfolio. In this specific embodiment of the portfolio analysis system, a suggested approach is shown. All steps of connecting to and using the online system are consistent with the previously described process.

After a user requests a historical analysis 601 be performed, the method according to the present invention allows the user to decide the target of the analysis 603. It is here that the user determines what is to be analyzed, an entire portfolio, an asset class, a market sector, or an individual financial instrument. Thereafter, the user can select what time horizon will be used in the analysis 605. This includes how much historical data to use, as well as what periodicity to use (i.e., daily, weekly, monthly or yearly data).

The process then generates a plurality of time series representing the historical position signals 607 of a financial market position over time. The historical position signal then is a time series whose values describe a market view and position size, i.e., quantity of instruments. These “signals” are used in the historical calculation. The system then connects to a data source to retrieve historical data 609 to be used for the historical analysis. Now that the target(s) of the process have been set by the user, the appropriate data is collected in order to execute the analysis.

The system then prompts the user to select analysis parameters 611. It is here that the risk analysis calculation parameters are determined, for example, what historical window to use for the volatility calculation, or what multiplier to scale the volatility in order to generate a dollar risk figure. After the analysis parameters and targets have been set, the system performs the requested historical analysis 613 and displays the results of the analysis 615.

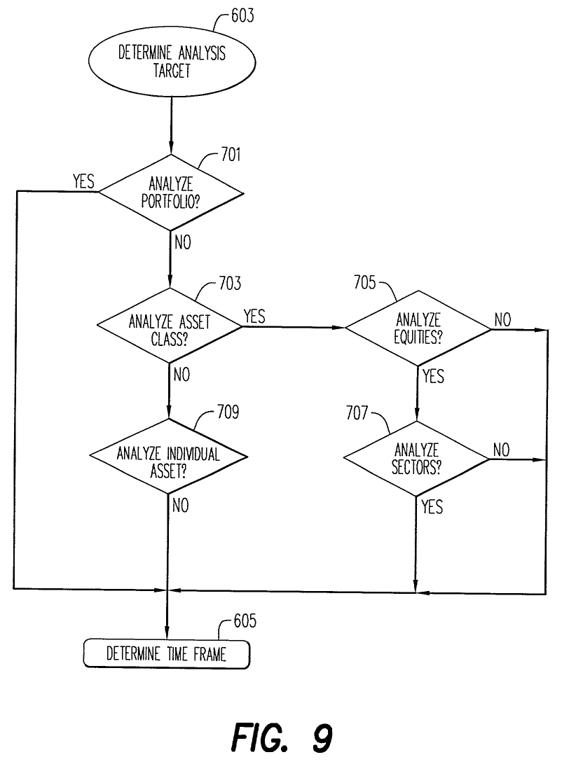

FIG. 9 includes the steps taken to determine the target of the historical analysis 603. The user may select for a portfolio-wide analysis to be performed 701. This allows a user to study the behavior of the entire portfolio over a historical time period. However, for a portfolio of stocks, commodities, currencies and bonds, a user may want to study the historical risk and returns of his or her stock risk only, and then see how the results relate to the portfolio as a whole. Therefore, if in step 701 the user does not select the portfolio-wide analysis, then the user may isolate a specific asset class to be analyzed 703, and progress to step 705. If the asset selected in step 703 was stocks, then the user may want to further refine the analysis into individual market sectors 707. If the asset selected in 703 was not stocks, the user is then left with selecting which individual asset within the portfolio to analyze 709. Thereafter, the user proceeds to the next step of the process, i.e., determining the time frame of the analysis 605.

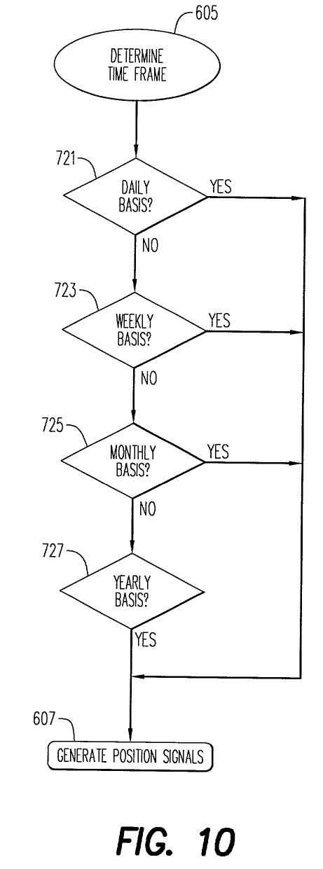

FIG. 10 describes the steps taken by the user to select the time frame of the analysis 605. Initially the user asked if a daily periodicity is to be used 721, if not weekly 723, if not monthly 725, if not yearly 727.

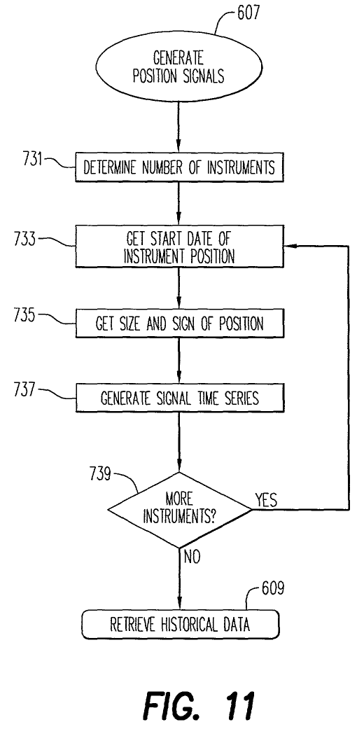

FIG. 11 is a description of how the system generates the position time series, or “signals” 607. Now that the target of the analysis has been decided on, the system must determine how many signals to generate 731. For example, this means generating a signal for each bond in the portfolio if the user selected the bond asset class as an analysis target. Thereafter, the system determines the start date of each position to be generated and analyzed 733. Thus, the system knows how far back in time to extend the analysis. Then it determines the size (quantity of financial instruments) and sign (market view, i.e., long or short) of each position to be analyzed 735. This accounts for market view (long/short), as well as different quantities of financial instruments in each position. Then the system generates the historical signal time series of the specific instrument 737. Finally, the system inquires if there are any more instruments in the analysis group 739. If there are, the system repeats 733, 735, 737 and 739 until there are no more instruments left in the analysis target group.

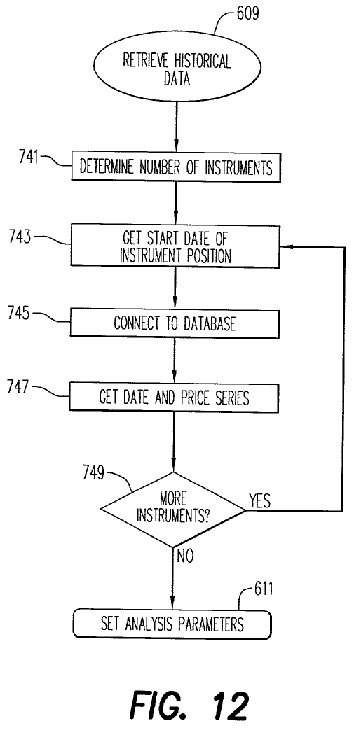

FIG. 12 is a description of how the system retrieves historical data relevant to the analysis 609. The system must determine how many time series to retrieve, each containing date and price information for every instrument to be analyzed 741. The system then determines the start date of each position to be generated and analyzed 743. Thus, the system knows how far back in time to request data. The system connects to a database 745, and the historical date and price time series of the specific instrument is extracted 747. Thereafter, the process inquires if there are any more instruments in the analysis group 749. If there are, steps 743, 745, 747 and 749 are repeated until there are no more instruments left in the analysis target group.

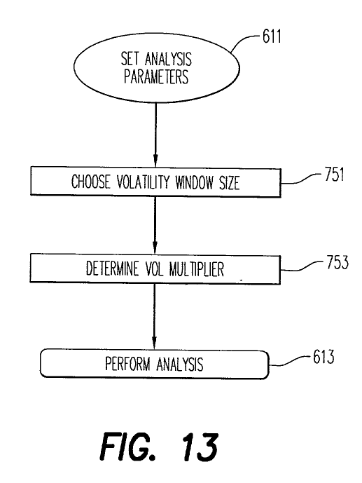

FIG. 13 describes the steps taken by the system to determine the parameters for the historical analysis 611. Initially the historical window used in the volatility calculation is determined 751. Thereafter, the volatility multiplier is determined 753 and the analysis is performed 613.

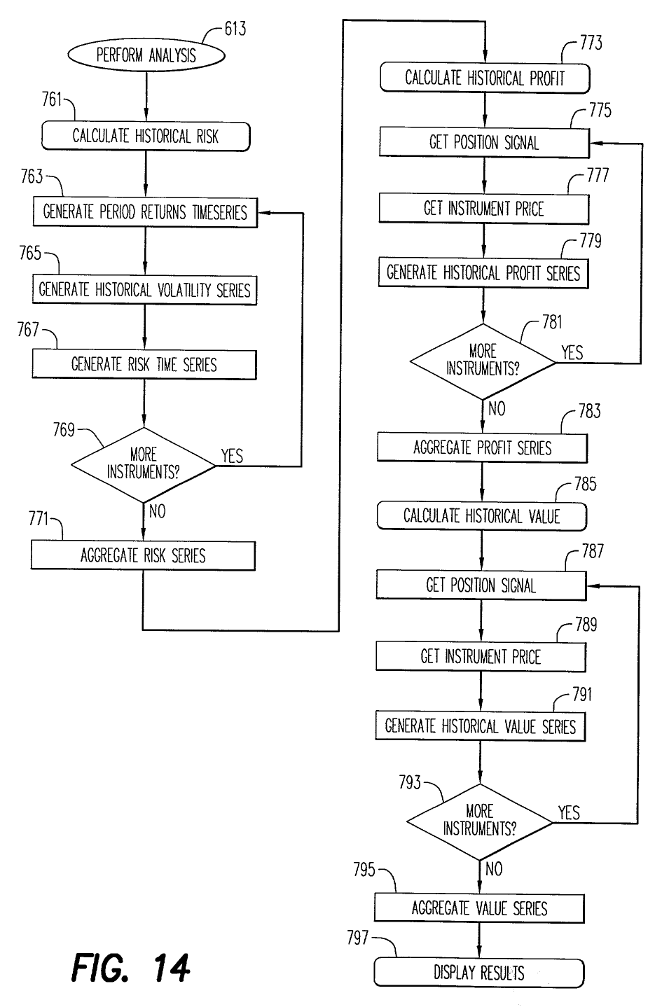

FIG. 14 includes the steps taken to perform the actual historical analysis 613. The system initially calculates the historical risk 761, then it generates a historical return time series 763, a historical volatility series 765 and risk time series 767 for a given instrument. Thereafter, the system determines if there are additional instruments in the analysis group 769. If there are, the system repeats steps 763, 765, 767 and 769. If there are no further instrument in the analysis group then the system mathematically aggregates all generated historical dollar risk time series into a single risk time series 771.

The system then proceeds with the historical profit calculation 773, wherein it retrieves the previously created a historical position signal time series 775, a historical price time series 777 and a historical profit time series 779 for a given instrument. The system then determines if there are additional instruments in the analysis group 781. If there are, the system repeats steps 775, 777, 779 and 781. If no additional instruments are found, then the system mathematically aggregates all generated historical profit time series into a single cumulative profit time series representing the collective historical profit of the analysis target group 783.

Next, the system conducts a historical value calculation 785, wherein the system retrieves the previously created a historical position signal time series 787, a historical price time series 789, and a historical value time series 791 for a given instrument. The system then determines if there are any additional instruments in the analysis group 793. If there are, the system repeats steps 787, 789, 791 and 793. If there are no more instruments in the analysis group, the system mathematically aggregates all generated historical value time series into a single value time series representing the collective historical value of the analysis target group 795 and then displays the results of the analysis 797.

Generating Historical Series of Risk

Calculating historical time series allows one to generate whole time series calculations of Volatility and Dollar Risk. Thus, one can compare what the volatility of an instrument was, for example, 2 months ago, versus what it is at present. Instead of selecting a sample set from a given time series of price information and then arriving at a single measurement, each point in the series is treated as a separate point in time and used to produce a measurement. Therefore, at each point in time, one looks back a certain number of points and calculates the volatility, as if it were the last point in the series. The number of points used for this ‘look-back’ is defined as the Historical Volatility Window (HVW). The result is a time series where the value of each point is the volatility measurement for the data ranging from that point in time to HVW points ago.

Historical Volatility

The Volatility measurement then becomes:

for k=J to Length of R,

$${V}_{k} = \sqrt{\frac{J \sum {R}_{i}^{2} - {( \sum {R}_{i} )}^{2}}{J ( J - 1 )}}$$

where i goes from (k-J) to k and J is the size (number of historical points used in the calculation) of the Historical Volatility Window.

For example, if J=30, and the period of the returns series, R, is daily, at each point in the input series, R, one looks back 30 days and then calculates the standard deviation. The first 29 days of series are not usable, however, and for this reason the calculation starts at k=J and not k=1. One can heuristically calculate the volatility at each of the 1 to (J−1) points by simply using as many days that are available. For example at k=27, one would use the 27 days available from k=27 to k=1 to generate a volatility measurement for point k=27. The calculation then becomes:

for k=1 to J−1,

$${V}_{k} = \sqrt{\frac{J \sum {R}_{i}^{2} - {( \sum {R}_{i} )}^{2}}{J ( J - 1 )}}$$

where i goes from (k-L) to k, and L goes from 1 to J, and

for k=J to Length of R,

$${V}_{k} = \sqrt{\frac{J \sum {R}_{i}^{2} - {( \sum {R}_{i} )}^{2}}{J ( J - 1 )}}$$

where i goes from (k-J) to k.

Historical Dollar Risk

The Dollar Risk calculation then becomes a time series operation as well. Now that a time series of volatility, V is available, one multiplies each point in this series by the Dollar Risk Scaling Factor, S (from above). The result is a time series where the value of each point is the Dollar Risk at that point in time:

DRᵢ=Vᵢ×S where i goes from 1 to Length of V

where V is the Volatility time series and DR is the Dollar Risk time series.

Aggregating Portfolio Risk

For a portfolio consisting of a plurality of financial instruments, the historical positions of each instrument become relevant when calculating each instrument's Dollar Risk, as well as that of the portfolio as a whole. For the historical calculation to be accurate, one must know the market view (long or short) as well as the quantity of each instrument in the portfolio at each point in time. It is therefore necessary to generate a time series consisting of quantity and sign (market view) at each point in time for each financial instrument in the portfolio.

An accurate calculation of historical risk would involve the application of the instrument position time series to the dollar Risk time series. The process is multiplicative:

FRᵢ=DRᵢ×PSᵢ, where i goes from 1 to Length of DR.

Where DR is the Dollar Risk time series PS is the historical instrument position time series, and FR is the result of the calculation, the Final Risk.

Generating an aggregate Dollar Risk time series for a plurality of financial instruments is accomplished by applying the position time series when generating the return time series R, for each instrument. R is then calculated by first generating a cumulative profit time series from a corresponding instrument price time series and position time series:

Pᵢ=[(Xᵢ−X₍ᵢ₋₁₎)×PSᵢ]+Oᵢ₋₁

where i goes from 2 to Length of X;

P₁=0;

P is the cumulative profit series;

X is the price series of the instrument; and

PS is the position time series of the instrument.

A cumulative profit, P is calculated for each instrument in the portfolio. In order to arrive at a portfolio-wide risk calculation, all of these P's are aggregated in to one profit series:

PW=ΣPₖ

where k goes from 1 to Number of Portfolio Instruments.

R is then calculated as before, by creating a time series of the differences of each point in PW.

Rᵢ=Pᵢ−P₍ᵢ₋₁₎

where i goes from 2 to Length of P.

The volatility, V of this new R is then calculated:

for k=1 to J−1,

$${V}_{k} = \sqrt{\frac{J \sum {R}_{i}^{2} - {( \sum {R}_{i} )}^{2}}{J ( J - 1 )}}$$

where i goes from (k-L) to k, and L goes from 1 to J, and

for k=J to Length of R,

$${V}_{k} = \sqrt{\frac{J \sum {R}_{i}^{2} - {( \sum {R}_{i} )}^{2}}{J ( J - 1 )}}$$

where i goes from (k-J) to k and J is the size of the Historical Volatility Window.

Finally, to arrive at the portfolio-wide Dollar Risk Series, the scaling factor, S is applied to this series:

DRᵢ=Vᵢ×S,

where i goes from 1 to Length of V.

DR is the final result, a historical time series of Dollar risk for the entire portfolio.

Portfolio Value

Similarly, historical value can be calculated and aggregated for the portfolio:

HVᵢ=PSᵢ×Xᵢ

where: i goes from 1 to length of X;

PS is the position time series for a given instrument; and

X is the corresponding price series for a given instrument.

The portfolio-wide value series is generated by aggregation as well:

HVP=ΣHVₖ

where k goes from 1 to Number of Portfolio Instruments.

The present invention also provides a method and system for simulating a theoretical portfolio and associated risk, and thereafter generating a trade list to implement the simulated results. Given that a user maintains a portfolio within an online system, the user may experiment with the portfolio's allocation to determine how the portfolio's risk would change. Furthermore, once the user has simulated the portfolio with desired characteristics, the user may also implement any theoretical changes that were made.

In this aspect of the present invention, the system receives a communication from the user terminal indicating a simulated change in a parameter of the portfolio. The system then calculates a simulated effect on the portfolio based on the simulated change.

The portfolio simulation and implementation system considers of four major analysis types, i.e., changes in parameters of the portfolio:

1. Manipulation of portfolio-wide risk.

2. Manipulation of individual position risk.

3. Manipulation of individual position quantity.

4. Addition of one or more new financial instruments.

Note that all simulations are made to a theoretical portfolio, leaving the user's original portfolio unaffected.

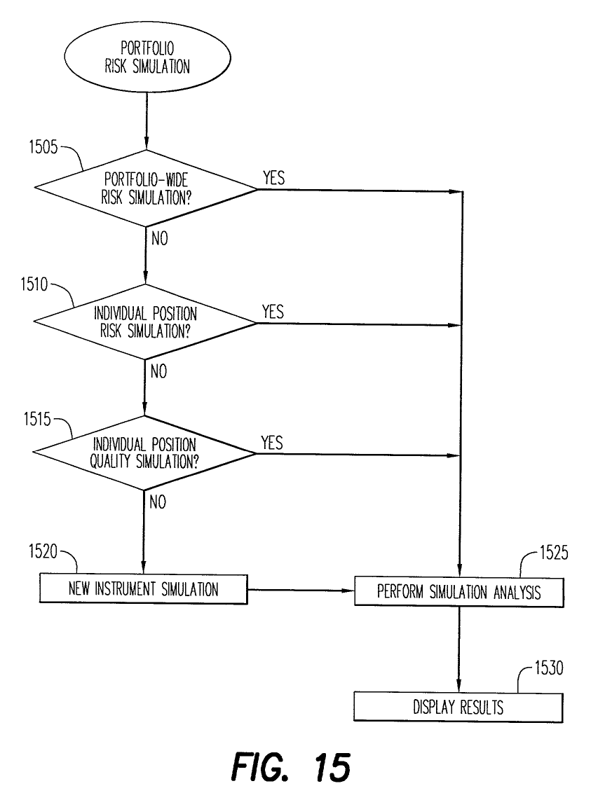

FIG. 15 is a flowchart showing the steps for accessing the portfolio simulation tool. The user selects a type of simulation by selecting one of the following steps: a Portfolio-Wide Risk Simulation in step 1505, an Individual Position Risk Simulation in step 1510, an Individual Position Quantity Simulation in step 1515, or a New Instrument Simulation in step 1520.

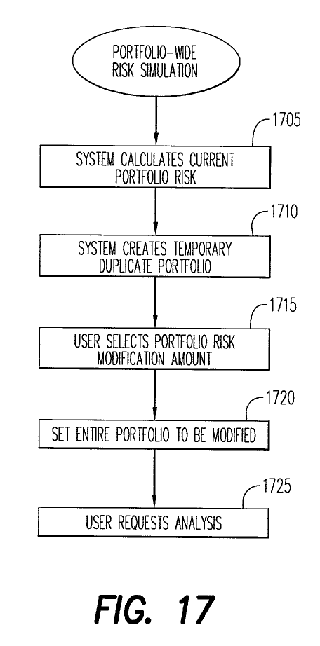

In step 1505, the user may select the Portfolio-Wide Risk Simulation. If the user does not select the Portfolio-Wide Risk Simulation, then the process advances to step 1510. If the user does select the Portfolio-Wide Risk Simulation, then the system proceeds with the Portfolio-Wide Risk Simulation, the details of which are shown in FIG. 17, and advances to step 1525.

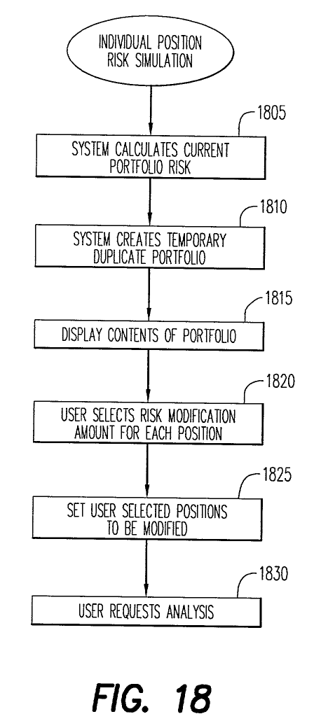

In step 1510, the user may select the Individual Position Risk Simulation. If the user does not select the Individual Position Risk Simulation, then the process advances to step 1515. If the user does select the Individual Position Risk Simulation, then the system proceeds with the Individual Position Risk Simulation, the details of which are shown in FIG. 18, and advances to step 1525.

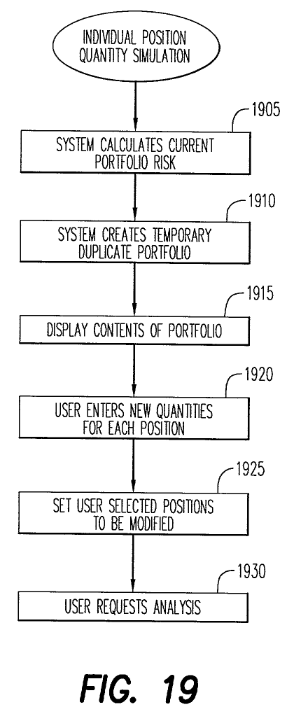

In step 1515, the user may select the Individual Position Quantity Simulation. If the user does not select the Individual Position Quantity Simulation, then the process advances to step 1520. If the user does select the Individual Position Quantity Simulation, then the system proceeds with the Individual Position Quantity Simulation, the details of which are shown in FIG. 19, and advances to step 1525.

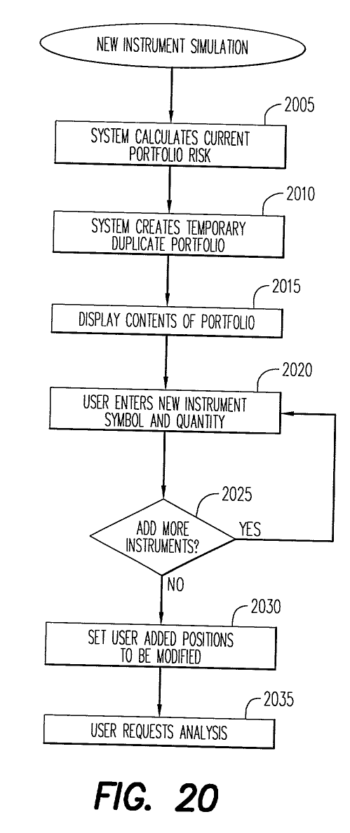

In step 1520, the system proceeds with the New Instrument Simulation, the details of which are shown in FIG. 20. After step 1520, the process advances to step 1525.

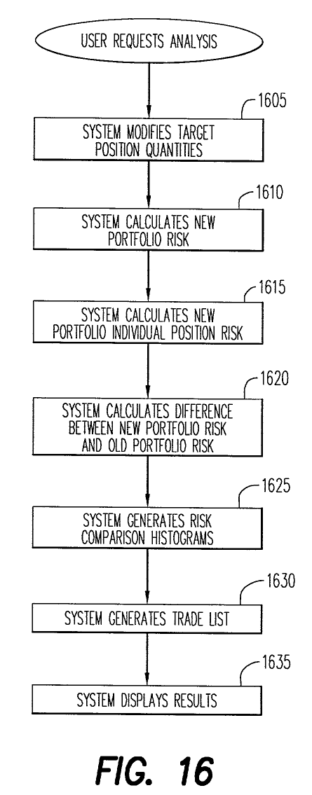

In step 1525, the system performs the simulation analysis. The details of performing the simulation analysis are shown in FIG. 16. After step 1525, the process advances to step 1530.

In step 1530, the system displays the results of the simulation. This includes displaying the contents of the new portfolio versus the contents of the old portfolio, displaying the differences in risk between the new portfolio and the old portfolio, displaying generated histograms, and displaying the list of trades generated by the simulation.

FIG. 17 is a flowchart showing the details of the Portfolio-Wide Risk Simulation of FIG. 15, step 1505.

In step 1705, the system calculates the risk of a user's current portfolio, as well as the risk of the portfolio's individual positions. The system then proceeds to step 1710, where the system creates a duplicate of the current portfolio. After this, in step 1715, the system provides a user interface tool to allow the user to input a percentage amount by which he or she desires the risk of the portfolio to change, positively or negatively. In step 1720, the system then makes the target of the change the entire portfolio. The system then proceeds to step 1725, where the user requests the analysis from the system.

FIG. 18 is a flowchart showing the details of the Individual Position Risk Simulation of FIG. 15, step 1510.

In step 1805, the system calculates the risk of a user's current portfolio, as well as the risk of the portfolio's individual positions. In step 1810, the system creates a duplicate of the current portfolio. In step 1815, the system displays the contents of a user's portfolio in tabular format. Each investment position within the portfolio is listed by name, quantity and position risk. In step 1820, a user interface is provided for inputting a desired percentage change in the risk of each position, positive or negative. The user inputs the desired changes. In step 1825, the system then makes the target of the change the positions modified by the user. In step 1830, the user then requests the analysis from the system.

FIG. 19 is a flowchart showing the details of the Individual Position Quantity Simulation of FIG. 15, step 1515.

In step 1905, the system calculates the risk of a user's current portfolio, as well as the risk of the portfolio's individual positions. In step 1910, the system creates a duplicate of the current portfolio. In step 1915, the system displays the contents of a user's portfolio in tabular format. Each investment position within the portfolio is listed by name, quantity and position risk. In step 1920, a user interface for inputting a new quantity for each position is provided. The user can enter in a different quantity for each position within the portfolio. In step 1925, the system then makes the target of the change the positions modified by the user. In step 1930, the user then requests the analysis from the system.

FIG. 20 is a flowchart showing the details of the New Instrument Simulation of FIG. 15, step 1520.

In step 2005 the system calculates the risk of a user's current portfolio, as well as the risk of the portfolio's individual positions. In step 2010, the system creates a duplicate of the current portfolio. In step 2015, the system displays the contents of a user's portfolio in tabular format. In step 2020, a user interface is provided for the addition of one or more financial instruments. The user inputs the symbol of the new instrument and the quantity to add. In step 2025, the system asks the user if the user has more instruments to add. If yes, then the system returns to step 2020, if not, then the system proceeds to step 2030. In step 2030, the system then makes the target of the change the positions added by the user. In step 2035, The user requests the analysis from the system.

FIG. 16 is a flowchart showing the details of the simulation analysis of FIG. 15, step 1525.

In step 1605 the system increases or decreases the quantities of each target investment within the portfolio. In step 1610, the system calculates the risk of this new portfolio. In step 1615, the system calculates the risk of each position within the portfolio. In step 1620, the system calculates the difference between the old and new risks. In step 1625, the system generates a series of histograms that graphically display the old portfolio risk versus the new portfolio risk, as well as the old risk of each individual position versus the new risk of each individual position. In step 1630, the system generates a list of trades to be done in order to make, i.e., actualize, the simulated changes. That is, executing the trades on the list effectively implements the changes, as previously simulated. The system then returns to FIG. 15, step 1530, where it outputs the results.

The following examples further illustrate the features of the four analysis techniques described above.

### EXAMPLE 1

### Manipulation of Portfolio-wide Risk

Assume the user wishes to simulate a current portfolio with 25% more risk. Each individual position quantity within the portfolio is increased by 25%. The system calculates the modified portfolio's risk, calculates the difference between the old and new risks and displays all risk differences graphically. A list of orders for each position in the portfolio is then outputted, ‘BUY’ orders for increasing long positions and ‘SELL’ orders for increasing short positions.

### EXAMPLE 2

### Manipulation of Individual Position Risk

Assume that a user's portfolio contains three positions, and the user wishes to simulate a current portfolio with the first position having 25% more risk, the second 50% more risk, and the third 25% less risk, i.e., −25% risk. Each individual position quantity within the portfolio is increased or decreased by its respective percentage amount. The system then calculates the modified portfolio's risk, the difference between the old and new risks, and displays all risk differences graphically. A list of orders for each position in the portfolio is then outputted. The change to the first position results in a ‘BUY’ order with 25% of the first position's original quantity. The change to the second position results in a ‘BUY’ order with 50% of the second position's original quantity. The change to the third position results in a ‘SELL’ order with −25% of the first position's original quantity.

### EXAMPLE 3

### Manipulation of Individual Position Quantity

Assume that a user's portfolio contains three positions each having a quantity of 100, and the user wishes to simulate a current portfolio with the first position's quantity being 1525, the second position's quantity being 85, and the third position's quantity being 200. The system calculates the modified portfolio's risk, calculates the difference between the old and new risks, and displays all risk differences graphically. A list of orders for each position in the portfolio is then outputted. The change to the first position results in a ‘BUY’ order with the quantity being 25. The change to the second position results in a ‘SELL’ order with a quantity of 15. The change to the third position results in a ‘BUY’ order with the quantity being 100.

### EXAMPLE 4

### Addition of One or More New Financial Instruments

Assume that a user's portfolio contains three positions, and the user wishes to simulate a current portfolio with the addition of a new financial instrument with a quantity of 100. The system calculates the modified portfolio's risk, calculates the difference between the old and new risks, and displays all risk differences graphically. A list of orders for each new position in the portfolio is then outputted. The addition of the new financial instrument results in a ‘BUY’ order with the quantity being 100.

The present invention offers many advantages over prior art systems, some of which are exemplified in the following list:

1. The present invention has an ability to analyze, simultaneously and sequentially, the portfolios of multiple users.

2. The present invention provides a method for instantly accessing or composing the makeup of an individual's portfolio via a network (e.g. the Internet). Users can perform portfolio risk analysis from any place in the world at any time.

3. The present invention eliminates the difficulty of information management. The user is relieved of the complexities of maintaining a historical database, analysis results and performance measures, as well as current market condition variables, historical market variables, and personal performance characteristics.

4. The present invention provides delivery of Value At Risk analysis over a distributed networked architecture.

5. The present invention provides dynamic asset and market sector sorting of a user's portfolio(s).

6. The present invention provides risk analysis of dynamically sorted sectors and asset classes.

7. The present invention provides graphical representation of risk analysis results in a comparative fashion. Users compare the risk of portfolio elements, asset classes, sectors, and individual positions via dynamically generated graphical results.

8. The present invention provides risk comparison of portfolios, asset classes, market sectors, and individual positions to market indexes.

9. The present invention provides graphical comparison of risk of portfolios, asset classes, market sectors, and individual positions to market indexes.

10. The present invention provides historical analysis of risk and the ability to generate graphs of risk over time. Users can compare the risk of a portfolio, asset class, market sector, or individual position vs. its risk at other points in time. It also provides the ability to view risk as a continuous function over time.

11. The present invention is accessible via a wireless device and a network (e.g. a Wireless Application Protocol (WAP) device and network).

Those skilled in the art, having the benefit of the teachings of the present invention may impart numerous modifications thereto. Such modifications are to be construed as lying within the scope of the present invention, as defined by the appended claims.

What is claimed is:

1. A method for analyzing an investment portfolio, comprising:
receiving a communication from a user terminal, via a computer network, to initiate a session for analyzing an investment portfolio for a user;
receiving a description of a financial instrument in said portfolio; and
calculating a risk for said financial instrument.

2. The method of claim 1, further comprising transmitting said risk to said user terminal.

3. The method of claim 1, wherein said step of receiving said description comprises receiving said description from said user terminal, via said computer network.

4. The method of claim 1, wherein said step of receiving said description comprises receiving said description from a database that stores said description on behalf of said user.

5. The method of claim 1, wherein said description of said financial instrument includes data selected from the group consisting of an identification of said financial instrument, a quantity, an indication of either a short position or a long position, and an initiation date.

6. The method of claim 1, further comprising calculating a return for said financial instrument.

7. The method of claim 1,
wherein said financial instrument is one of a plurality of financial instruments in said portfolio, and
wherein said method further comprises calculating a risk for said portfolio.

8. The method of claim 1,
wherein said financial instrument is a member of a set of financial instruments in a class of asset, and
wherein said method further comprises calculating a risk for said set of financial instruments.

9. The method of claim 8, wherein said class of asset is selected from the group consisting of commodities, currencies, bonds, stocks, and a stock sector.

10. The method of claim 1, further comprising calculating an historical risk for said financial instrument.

11. The method of claim 1, further comprising calculating a profit for said financial instrument.

12. The method of claim 1, further comprising calculating an historical profit for said financial instrument.

13. The method of claim 1, further comprising calculating a value for said financial instrument.

14. The method of claim 1, further comprising calculating an historical value for said financial instrument.

15. The method of claim 1, further comprising the steps of:
receiving a communication from said user terminal indicating a simulated change in a parameter of said portfolio; and
calculating a simulated effect on said portfolio based on said simulated change.

16. The method of claim 15, wherein said parameter is selected from the group consisting of a risk for said portfolio, a risk for said financial instrument, a quantity of said financial instrument, and an additional financial instrument.

17. The method of claim 15, further comprising the step of generating a trade list to actualize said simulated change.

18. A system for analyzing an investment portfolio, comprising a processor that performs the steps of:
receiving a communication from a user terminal, via a computer network, to initiate a session for analyzing an investment portfolio for a user;
receiving a description of a financial instrument in said portfolio; and
calculating a risk for said financial instrument.

19. The system of claim 18, wherein said processor further performs the step of transmitting said risk to said user terminal.

20. The system of claim 18, wherein said step of receiving said description comprises receiving said description from said user terminal, via said computer network.

21. The system of claim 18, wherein said step of receiving said description comprises receiving said description from a database that stores said description on behalf of said user.

22. The system of claim 18, wherein said description of said financial instrument includes data selected from the group consisting of an identification of said financial instrument, a quantity, an indication of either a short position or a long position, and an initiation date.

23. The system of claim 18, wherein said processor further performs the step of calculating a return for said financial instrument.

24. The system of claim 18,
wherein said financial instrument is one of a plurality of financial instruments in said portfolio, and
wherein said processor further performs the step of calculating a risk for said portfolio.

25. The system of claim 18,
wherein said financial instrument is a member of a set of financial instruments in a class of asset, and
wherein said processor further performs the step of calculating a risk for said set of financial instruments.

26. The system of claim 25, wherein said class of asset is selected from the group consisting of commodities, currencies, bonds, stocks, and a stock sector.

27. The system of claim 18, wherein said processor further performs the step of calculating an historical risk for said financial instrument.

28. The system of claim 18, wherein said processor further performs the step of calculating a profit for said financial instrument.

29. The system of claim 18, wherein said processor further performs the step of calculating an historical profit for said financial instrument.

30. The system of claim 18, wherein said processor further performs the step of calculating a value for said financial instrument.

31. The system of claim 18, wherein said processor further performs the step of calculating an historical value for said financial instrument.

32. The system of claim 18, wherein said processor further performs the steps of:
receiving a communication from said user terminal indicating a simulated change in a parameter of said portfolio; and
calculating a simulated effect on said portfolio based on said simulated change.

33. The system of claim 32, wherein said parameter is selected from the group consisting of a risk for said portfolio, a risk for said financial instrument, a quantity of said financial instrument, and an additional financial instrument.

34. The system of claim 32, wherein said processor further performs the step of generating a trade list to actualize said simulated change.

35. A storage media including instructions for controlling a processor that, in turn, analyzes an investment portfolio, said storage media comprising:
a module for controlling said processor to receive a communication from a user terminal, via a computer network, to initiate a session for analyzing an investment portfolio for a user;
a module for controlling said processor to receive a description of a financial instrument in said portfolio; and
a module for controlling said processor to calculate a risk for said financial instrument.

36. The storage media of claim 35, further comprising a module for controlling said processor to transmit said risk to said user terminal.

37. The storage media of claim 35, wherein said module for controlling said processor to receive said description comprises a module for controlling said processor to receive said description from said user terminal, via said computer network.

38. The storage media of claim 35, wherein said module for controlling said processor to receive said description comprises a module for controlling said processor to receive said description from a database that stores said description on behalf of said user.

39. The storage media of claim 35, wherein said description of said financial instrument includes data selected from the group consisting of an identification of said financial instrument, a quantity, an indication of either a short position or a long position, and an initiation date.

40. The storage media of claim 35, further comprising a module for controlling said processor to calculate a return for said financial instrument.

41. The storage media of claim 35, wherein said financial instrument is one of a plurality of financial instruments in said portfolio, and wherein said storage media further comprises a module for controlling said processor to calculate a risk for said portfolio.

42. The storage media of claim 35, wherein said financial instrument is a member of a set of financial instruments in a class of asset, and wherein said storage media further comprises a module for controlling said processor to calculate a risk for said set of financial instruments.

43. The storage media of claim 42, wherein said class of asset is selected from the group consisting of commodities, currencies, bonds, stocks, and a stock sector.

44. The storage media of claim 35, further comprising a module for controlling said processor to calculate an historical risk for said financial instrument.

45. The storage media of claim 35, further comprising a module for controlling said processor to calculate a profit for said financial instrument.

46. The storage media of claim 35, further comprising a module for controlling said processor to calculate an historical profit for said financial instrument.

47. The storage media of claim 35, further comprising a module for controlling said processor to calculate a value for said financial instrument.

48. The storage media of claim 35, further comprising a module for controlling said processor to calculate an historical value for said financial instrument.

49. The storage media of claim 35, further comprising:
a module for controlling said processor to receive a communication from said user terminal indicating a simulated change in a parameter of said portfolio; and
a module for controlling said processor to calculate a simulated effect on said portfolio based on said simulated change.

50. The storage media of claim 49, wherein said parameter is selected from the group consisting of a risk for said portfolio, a risk for said financial instrument, a quantity of said financial instrument, and an additional financial instrument.

51. The storage media of claim 49, further comprising a module for controlling said processor to generate a trade list to actualize said simulated change.
